(19) United States
(12) Patent Application Publication
(10) Pub. No.: US 2008/0267750 A1
(43) Pub. Date: Oct. 30, 2008

(54) METHODS FOR MOVING OVENS, AND OVENS HAVING MEANS FOR RELEASABLY ATTACHING TO A PLURALITY OF CASTERS

(76) Inventor: Marcus E. BRAMHALL, Dallas, NC (US)

Correspondence Address: HESLIN ROTHENBERG FARLEY & MESITI PC, 5 COLUMBIA CIRCLE, ALBANY, NY, 12203, US

(21) Appl. No.: 12/111,506

(22) Filed: Apr. 29, 2008

Related U.S. Application Data
(60) Provisional application No. 60/915,012, filed on Apr. 30, 2007.

(51) Int. Cl. B65G 7/00

(52) U.S. Cl. 414/331.06; 126/19 M

(57) ABSTRACT

An oven includes a housing, which is configured to be releasably attachable to a removable set of means such as casters so that the oven may be easily moved particularly during installation.

### CLAIM TO PRIORITY AND CROSS-REFERENCE TO RELATED APPLICATIONS

This application claims the benefit of U.S. Provisional Application No. 60/915,012, filed Apr. 30, 2007, entitled “Ovens, And Burner Tube Assemblies, Cold Air Return Baffles, Finger Ducts, And Removable Wheels Therefor”, which is hereby incorporated herein by reference in its entirety.

This application is related to commonly owned, and co-filed U.S. patent application Ser. No. ______, entitled “Ovens, Burner Tube Assemblies, And Methods For Delivering Air To A Gas Power Burner,” by Bramhall, (Docket No. 2869.015A); U.S. patent application Ser. No. ______, entitled “Ovens Having A Cold Air Return Baffle And Methods For Circulating Air In An Oven,” by Bramhall, (Docket No. 2869.015B); and U.S. patent application Ser. No. ______, entitled “Ovens, Finger Ducts Therefor, And Methods For Distributing Air In A Finger Duct,” by Bramhall, (Docket No. 2869.015C), which are hereby incorporated herein by reference in their entirety.

### FIELD OF THE INVENTION

This invention relates generally to ovens, and more specifically, to methods for moving ovens such as during installation.

### BACKGROUND OF THE INVENTION

Ovens for heat-treating products oftentimes employ a burner for combusting a fuel such as gas or an electric means for heating the oven. Food preparation ovens such as food preparation ovens for preparing pizza and other types of food products typically employ jets of hot gaseous fluid such as hot air for baking or cooking the food product.

For example, conventional pizza ovens often employ a conveyor for transporting the food into and out of the oven. Typically, the pizza ovens are supported on a support or legs that are attached to the bottom of the oven. The legs may have wheels attached to the ends of the legs. In addition, pizza ovens are often stacked one on top of another oven to minimize the spaced required, for example, in a kitchen.

U.S. Pat. No. 7,059,317 issued to Kobayashi discloses a conveyor oven for commercial use in which foods, such as a pizza, are placed on a conveyer and heated. The conveyor oven includes a plurality of legs disposed at the corners of the conveyor oven for supporting the conveyor oven above the surface of the floor or ground. Each of the legs has a wheel disposed at the lower end thereof.

U.S. Patent Application Publication No. 2007/0012307 by Wiker et al. disclose a conveyor oven having a plurality of legs disposed at the corners of the conveyor oven for supporting the conveyor oven above the surface of the floor or ground. Each of the legs has a wheel disposed at the lower end thereof.

U.S. Patent Application Publication No. 2007/0006865 by Wiker et al. disclose a self-cleaning conveyor oven having a plurality of legs disposed at the corners of the conveyor oven for supporting the conveyor oven above the surface of the floor or ground. Each of the legs has a wheel disposed at the lower end thereof.

U.S. Pat. No. 6,192,877 issued to Moshonas et al. and U.S. Pat. No. 6,526,961 issued to Hardenburger disclose conveyor ovens supported on legs having rollers. U.S. Pat. No. 6,655,373 issued to Wiker appears to illustrate a conveyor oven supported on legs having wheels.

There is a need for further ovens which may be readily and easily moved from one location to another location, particularly during installation.

### SUMMARY OF THE INVENTION

The present invention, in a first aspect, is directed to a method for moving an oven. The method includes providing an oven having a housing having a normal operating orientation defining a front side, a rear side, a right side, a left side, a top, a bottom, a chamber therein for receiving and heating a heat treatable product, and a plurality of connectors attached to one of the sides of the oven for releasably connecting to a plurality of casters. A plurality of casters are provided and attached to the plurality of connectors of the oven. The oven is orientated so that the top and the bottom are disposed vertically, and the oven is supported by the plurality of casters on a horizontal surface. The oven supported on the plurality of casters is rolled along the horizontal surface from a first location to a second location. The plurality of casters are removed from the plurality of connectors of the oven, and the oven is oriented to its normal operating orientation.

The present invention, in a second aspect, is directed to a method for moving an oven, the method includes providing a first oven having a housing having a normal operating orientation defining a front side, a rear side, a right side, a left side, a top, a bottom, a chamber therein for receiving and heating a heat treatable product, and a first plurality of connectors attached to one of the sides of the oven for releasably connecting to a plurality of casters. A plurality of casters are provided and attached to the first plurality of connectors of the first oven. The first oven is orientated so that the top and the bottom are disposed vertically, and the oven is supported by the plurality of casters on a horizontal surface. The first oven supported on the plurality of casters is rolled along the horizontal surface from a first location to a second location. The plurality of casters is removed from the first plurality of connectors of the first oven, the first oven is orientated to its normal operating position, and the first oven is supported at the second location in an elevated position above the horizontal surface in an installed position. A second oven is provided having a housing having a normal operating orientation defining a front side, a rear side, a right side, a left side, a top, a bottom, a chamber therein for receiving and heating a heat treatable product, and a plurality of second connectors attached to one of the sides of the oven for releasably connecting to a plurality of casters. The plurality of casters are attached to the second plurality of connectors of the second oven. The second oven is orientated so that the top and the bottom are disposed vertically, and the second oven supported by the plurality of casters on the horizontal surface. The second oven supported on the plurality of casters is rolled along the horizontal surface from the first location to the second location. The plurality of casters are removed from the second plurality of connectors of the second oven, the second oven is orientated to its normal operating position, and the second oven is supported at the second location in a stacked configuration above the first oven in an installed position.

The present invention, in a third aspect, is directed to an oven for heating a heat treatable product. The oven includes a housing having a normal operating orientation defining a front side, a rear side, a right side, a left side, a top, a bottom, a chamber therein for receiving and heating a heat treatable product, and a first plurality of connectors attached to one of the sides of the oven for releasably connecting to a plurality of casters.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a front perspective view of one embodiment of a plurality of stacked ovens in accordance with the present invention;

FIG. 2 is a rear perspective view of one of the ovens of FIG. 1;

FIG. 3 is a rear perspective view of the oven of FIG. 2 with a plurality of casters attached;

FIG. 4 is an elevational view of the oven of FIG. 2 in a rotated orientation wherein the oven is supported by the casters on a horizontal surface;

FIG. 5 is a perspective view of the oven of FIG. 2 in its normal operating position supported by a plurality of legs;

FIG. 6 is a flowchart of one embodiment of a method for moving an oven in accordance with the present invention; and

FIGS. 7 and 8 is a flowchart of another embodiment of a method for moving a plurality of ovens in accordance with the present invention.

### DETAILED DESCRIPTION OF THE INVENTION

The present invention is directed to ovens for heat treating products and may include ovens for heat treating products such as ovens for preparing pizza and similar types of food products. For example, the ovens may be configured as an impingement oven having a conveyor wherein food products are baked or cooked by means of jets of hot gaseous fluid such as hot air and wherein the hot air jets are impinged directly upon localized areas of the food product.

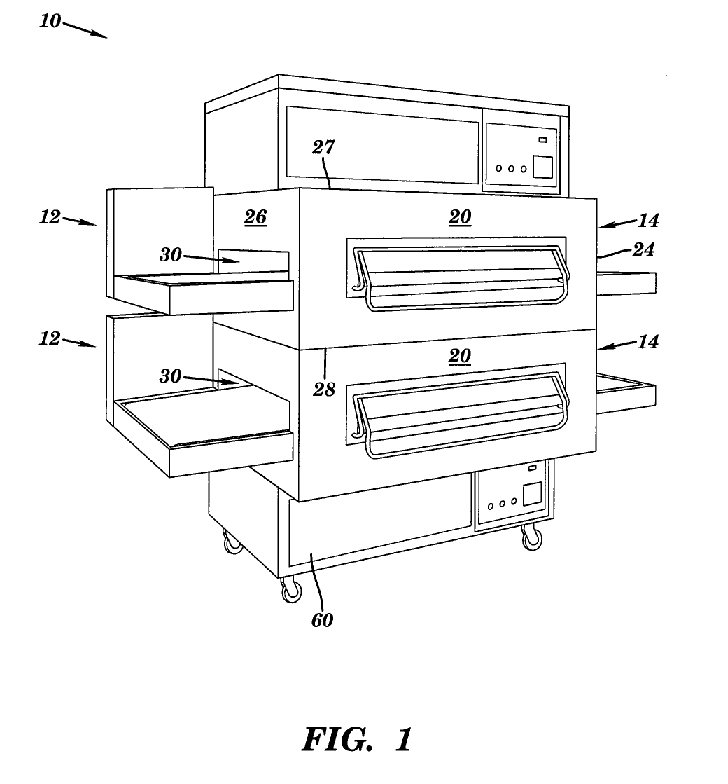

FIG. 1 illustrates a double stacked oven 10 in accordance with the present invention for heat treating products and may include a plurality of ovens 12 for preparing pizza and similar types of food products. For example, a gas power burner may be used in an impingement oven having a conveyor wherein food products are baked or cooked by means of jets of hot gaseous fluid such as hot air and wherein the hot air jets are impinged directly upon localized areas of the food product. Alternatively, an electrical heating element or means may be employed instead of the gas burner. A shroud covers a conveyor drive motor operatively connected via a gear motor, a sprocket, and a chain, for moving the conveyor.

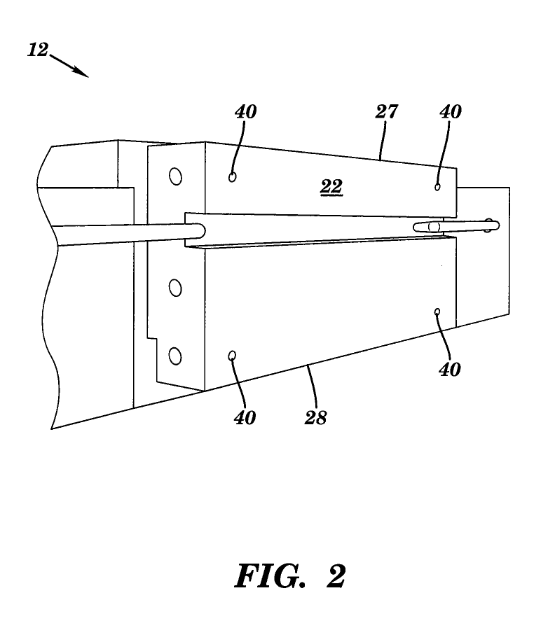

With reference still to FIG. 1, oven 12 is illustrated in its a normal operating orientation. Oven 12 generally includes a housing 14 having a front side 20, a rear side 22 (FIG. 2), a right side 24, a left side 26, a top 27, a bottom 28, and a chamber 30 therein for receiving and heating a heat treatable product.

In one aspect, the present invention is directed to ovens in which the oven is configured to be releasably attachable to a removable set of means such as wheels or casters so that the oven may be easily moved particularly during installation and removal.

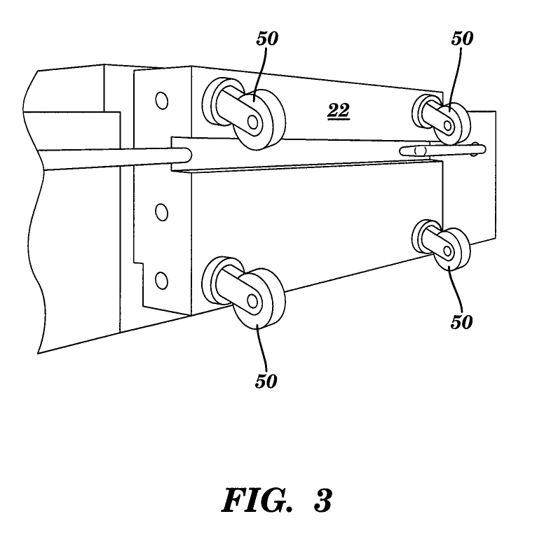

As best shown in FIGS. 2 and 3, a plurality of connectors 40 (FIG. 2) are attached to one of the sides such as rear side 22 of the oven for releasably connecting to a plurality of casters 50 (FIG. 3). For example, rear side 22 may be provided with premounted installation means or a plurality of releasable connectors for removably attaching to the means for moving the oven. For example, the rear of the housing may include a plurality of fittings having threaded holes for receiving a threaded bolt (not shown) of caster 50 (FIG. 3). The casters may be a rigid or stationary caster in which the wheel assembly only permits a straight line movement, or a swivel caster in which the wheel assembly allows rotation through 360-degrees and permits movement in any direction, i.e., the swivel caster may be free to swivel about an axis at right angles to the axis of the wheel. Typically, a caster has an offset steering pivot such that the wheel will automatically swivel to align itself to the direction from which it is pushed. A typical caster may include a mounting plate, one or more bearings, a U-shaped member having holes at the ends of legs through which a bolt may extend for supporting a wheel.

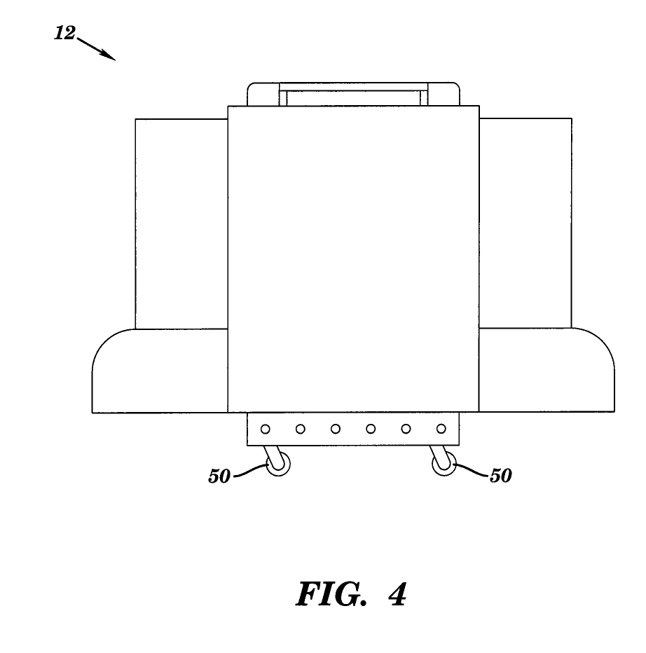

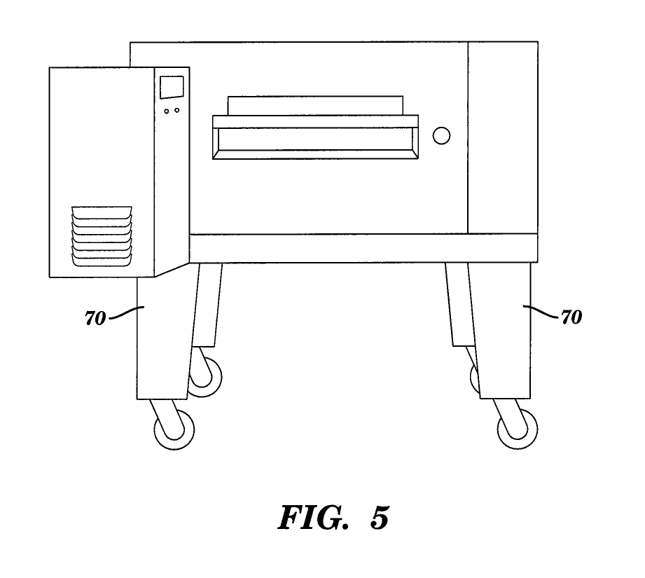

During delivery of the oven to a desired location, an installer may attach the casters to the rear of the oven. Thereafter, the oven may be rotated so that the rear of the oven is supported by the casters on the ground as shown in FIG. 4. The oven may then be readily moved to the location for installation. At the location for installation, the oven is orientated to its normal operating orientation the casters are removed, and the oven is installed such as on a support 60 as shown in FIG. 1 or on a plurality of legs 70 as shown in FIG. 5. The casters may be used to move another oven such that a plurality of ovens may be stacked one on top of the other. If the oven needs to be removed, the oven may be moved, the casters installed, and the oven tilted on its side so that the casters support the oven on the ground.

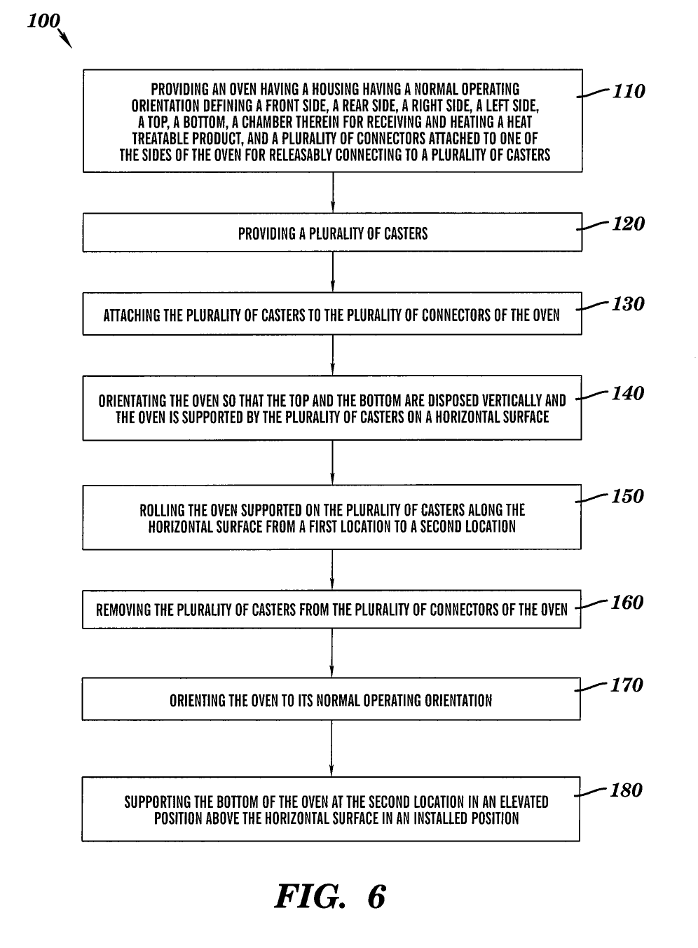

FIG. 6 illustrates a flowchart of a method 100 for moving an oven and includes at 110, providing an oven having a housing having a normal operating orientation defining a front side, a rear side, a right side, a left side, a top, a bottom, a chamber therein for receiving and heating a heat treatable product, and a plurality of connectors attached to one of the sides of the oven for releasably connecting to a plurality of casters. At 120, a plurality of casters is provided. At 130, the plurality of casters is attached to the plurality of connectors of the oven, and the oven is orientated so that the top and the bottom are disposed vertically and the oven is supported by the plurality of casters on a horizontal surface at 140. The oven supported on the plurality of casters is rolled along the horizontal surface from a first location to a second location, at 150. The plurality of casters are removed from the plurality of connectors of the oven at 160, the oven is orientated to its normal operating orientation at 170, and the bottom of the oven is supported at the second location in an elevated position above the horizontal surface in an installed position at 180.

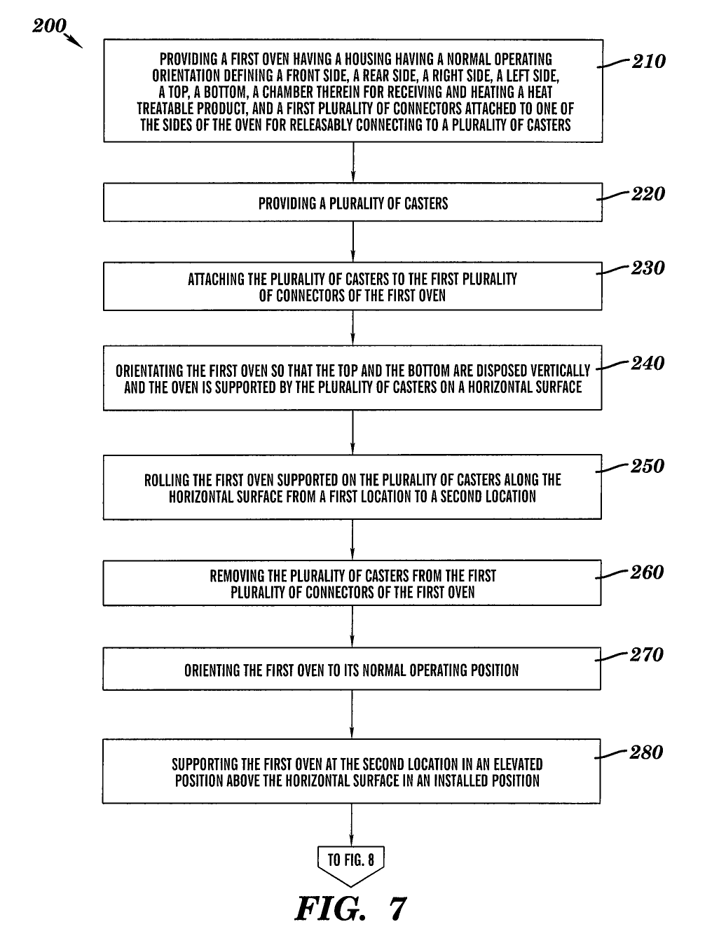

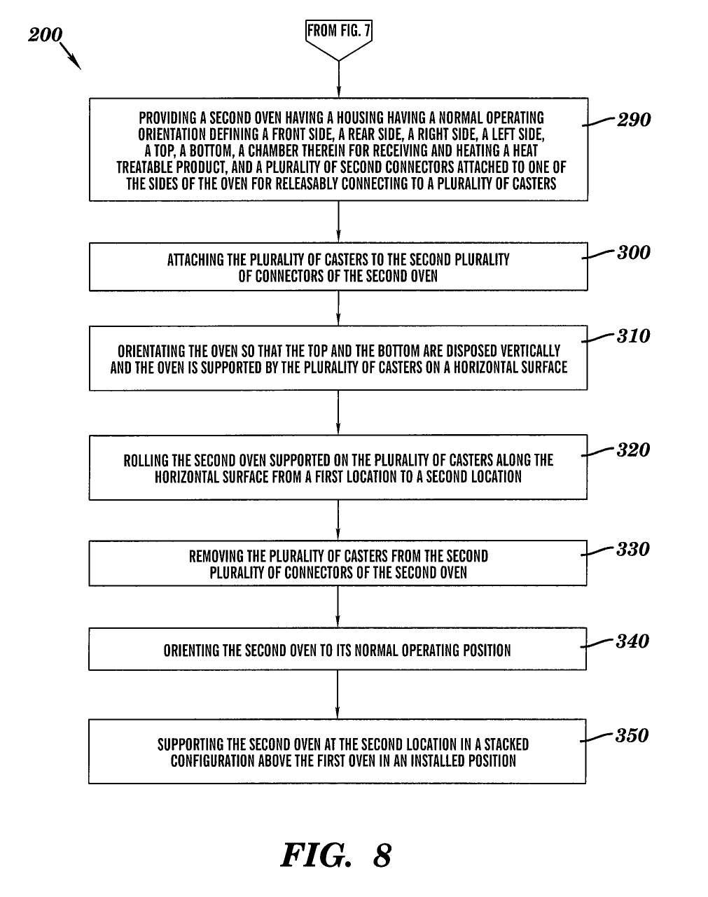

FIGS. 7 and 8 illustrate a flowchart of a method 200 for moving a plurality of ovens. As initially shown in FIG. 7, method 200 includes at 210, providing a first oven having a housing having a normal operating orientation defining a front side, a rear side, a right side, a left side, a top, a bottom, a chamber therein for receiving and heating a heat treatable product, and a plurality of connectors attached to one of the sides of the first oven for releasably connecting to a plurality of casters. At 220, a plurality of casters is provided. At 230, the plurality of casters is attached to the plurality of connectors of the first oven, and the first oven is orientated so that the top and the bottom are disposed vertically and the first oven is supported by the plurality of casters on a horizontal surface at 240. The first oven supported on the plurality of casters is rolled along the horizontal surface from a first location to a second location, at 250. The plurality of casters is removed from the plurality of connectors of the first oven at 260, the first oven is orientated to its normal operating orientation at 270, and the bottom of the first oven is supported at the second location in an elevated position above the horizontal surface in an installed position at 280.

As shown in FIG. 8, method 200 further includes at 290, providing a second oven having a housing having a normal operating orientation defining a front side, a rear side, a right side, a left side, a top, a bottom, a chamber therein for receiving and heating a heat treatable product, and a plurality of connectors attached to one of the sides of the second oven for releasably connecting to a plurality of casters. At 300, the plurality of casters is attached to the plurality of connectors of the second oven, and the second oven is orientated so that the top and the bottom are disposed vertically and the second oven is supported by the plurality of casters on a horizontal surface at 310. The second oven supported on the plurality of casters is rolled along the horizontal surface from the first location to the second location, at 320. The plurality of casters is removed from the plurality of connectors of the second oven at 330, the second oven is orientated to its normal operating orientation at 340, and the bottom of the second oven is supported at the second locations in a stacked configuration above the first oven in an installed position at 350.

The various components of the present invention described above may be incorporated into the food preparation ovens disclosed in U.S. Pat. No. 4,846,143 issued to Csadenyl, U.S. Pat. No. 5,025,775 issued to Crisp, and applicant's co-filed U.S. patent application as noted above, the entire subject matter of these patents and applications being incorporated herein by reference.

Thus, while various embodiments of the present invention have been illustrated and described, it will be appreciated to those skilled in the art that many changes and modifications may be made thereunto without departing from the spirit and scope of the invention.

1. A method for moving an oven, the method comprising:
providing an oven having a housing having a normal operating orientation defining a front side, a rear side, a right side, a left side, a top, a bottom, a chamber therein for receiving and heating a heat treatable product, and a plurality of connectors attached to one of the sides of the oven for releasably connecting to a plurality of casters;
providing a plurality of casters;
attaching the plurality of casters to the plurality of connectors of the oven;
orientating the oven so that the top and the bottom are disposed vertically and the oven is supported by the plurality of casters on a horizontal surface;
rolling the oven supported on the plurality of casters along the horizontal surface from a first location to a second location;
removing the plurality of casters from the plurality of connectors of the oven; and
orienting the oven to its normal operating orientation.

2. The method of claim 1 wherein the plurality of casters comprises a plurality of swivel casters.

3. The method of claim 1 wherein the plurality of connectors are disposed on the rear side, and the attaching comprises attaching the plurality of casters to the plurality of connectors on the rear side of the oven.

4. The method of claim 1 further comprising supporting the bottom of the oven at the second location in an elevated position above the horizontal surface in an installed position.

5. The method of claim 4 wherein the supporting comprising attaching a plurality of legs to the bottom of the oven.

6. The method of claim 1 wherein the oven comprises a conveyor for transporting the heat treatable product into and out of the oven.

7. The method of claim 1 wherein the oven comprises a conveyor for transporting the heat treatable product into and out of the oven, the plurality of casters comprises a plurality of swivel casters, the plurality of connectors are disposed on the rear side of the oven, and the attaching comprises attaching the plurality of swivel casters to the plurality of connectors on the rear side of the oven, and further comprising supporting the bottom of the oven at the second location in an elevated position above the horizontal surface in an installed position.

8. A method for moving an oven, the method comprising:
providing a first oven having a housing having a normal operating orientation defining a front side, a rear side, a right side, a left side, a top, a bottom, a chamber therein for receiving and heating a heat treatable product, and a first plurality of connectors attached to one of the sides of the oven for releasably connecting to a plurality of casters;
providing a plurality of casters;
attaching the plurality of casters to the first plurality of connectors of the first oven;
orientating the first oven so that the top and the bottom are disposed vertically and the oven is supported by the plurality of casters on a horizontal surface;
rolling the first oven supported on the plurality of casters along the horizontal surface from a first location to a second location;
removing the plurality of casters from the first plurality of connectors of the first oven;
orienting the first oven to its normal operating position;
supporting the first oven at the second location in an elevated position above the horizontal surface in an installed position;
providing a second oven having a housing having a normal operating orientation defining a front side, a rear side, a right side, a left side, a top, a bottom, and a chamber therein for receiving and heating a heat treatable product, and a plurality of second connectors attached to one of the sides of the oven for releasably connecting to a plurality of casters;
attaching the plurality of casters to the second plurality of connectors of the second oven;
orientating the second oven so that the top and the bottom are disposed vertically and the second oven is supported by the plurality of casters on the horizontal surface;
rolling the second oven supported on the plurality of casters along the horizontal surface from the first location to the second location;
removing the plurality of casters from the second plurality of connectors of the second oven;
orienting the second oven to its normal operating position; and
supporting the second oven at the second location in a stacked configuration above the first oven in an installed position.

9. The method of claim 8 wherein the plurality of casters comprises a plurality of swivel casters.

10. The method of claim 8 wherein the first plurality of connectors are disposed on the rear side of the first oven, and the attaching the plurality of casters to the first plurality of connectors of the first oven comprises attaching the plurality of casters to the first plurality of connectors on the rear side of the first oven, and wherein the second plurality of connectors are disposed on the rear side of the second oven, and the attaching the plurality of casters to the second plurality of connectors of the second oven comprises attaching the plurality of casters to the second plurality of connectors on the rear side of the second oven.

11. The method of claim 8 wherein the supporting the first oven comprises attaching at least one of a support and a plurality of legs to the bottom of the first oven.

12. The method of claim 8 wherein the first oven and the second over comprise a conveyor for transporting the heat treatable product into and out of the oven.

13. The method of claim 8 wherein the first oven comprises a first conveyor for transporting the heat treatable product into and out of the first oven, the second oven comprises a second conveyor for transporting the heat treatable product into and out of the second oven, the plurality of casters comprises a plurality of swivel casters, the plurality of first connectors are disposed on the rear side of the first oven, the plurality of second connectors are disposed on the rear side of the second oven, the attaching the plurality of casters to the first plurality of connectors of the first oven comprises attaching the plurality of swivel casters to the first plurality of connectors on the rear side of the first oven, and the attaching the plurality of casters to the second plurality of connectors of the second oven comprises attaching the plurality of swivel casters to the second plurality of connectors on the rear side of the second oven.

14. An oven for heating a heat treatable product, the oven comprising:
a housing having a normal operating orientation defining a front side, a rear side, a right side, a left side, a top, a bottom, a chamber therein for receiving and heating a heat treatable product; and
a first plurality of connectors attached to one of the sides of the oven for releasably connecting to a plurality of casters.

15. The oven of claim 14 wherein the plurality of connectors are disposed on said rear side so that said oven is orientatable with the top and the bottom being disposed in a vertically orientation when the oven is supported by the plurality of casters on a horizontal surface.

16. The oven of claim 14 wherein said plurality of connectors are disposed adjacent to the corners of said side of said housing.

17. The oven of claim 14 wherein said plurality of connectors comprises a plurality of treaded connectors.

18. The method of claim 14 wherein said oven comprises a conveyor for transporting the heat treatable product into and out of the oven.

19. The oven of claim 14 further comprising providing a plurality of casters releasably connectable to said plurality of connectors.

20. The oven of claim 14 further comprising a plurality of swivel casters releasably connectable to said plurality of connectors.
